(19) United States
(12) Patent Application Publication
(10) Pub. No.: US 2011/0097225 A1
(43) Pub. Date: Apr. 28, 2011

(54) AIR COMPRESSION AND EXPANSION SYSTEM WITH SINGLE SHAFT COMPRESSOR AND TURBINE ARRANGEMENT

(76) Inventor: Sebastian W. Freund, Unterfohring (DE)

(21) Appl. No.: 12/607,239

(22) Filed: Oct. 28, 2009

(51) Int. Cl. F04D 25/06; B23P 11/00

(52) U.S. Cl. 417/423.5; 29/888.025

(57) ABSTRACT

An air compression and expansion system having a combined motor-generator unit and a single drive shaft coupled to compressors and expanders is disclosed. The system includes a motor-generator unit, a drive shaft connected to the motor-generator unit configured to transmit rotational power to and from the motor-generator unit, a compressor system selectively coupleable to the drive shaft and positioned thereabout, and a turbine system selectively coupleable to the drive shaft and positioned thereabout, the turbine system positioned with the compressor system on a common side of the motor-generator unit. The air compression and expansion system also includes a compressor clutch attached to the compressor system and a turbine clutch attached to the turbine system. The compressor clutch and the turbine clutch are arranged coaxially about the drive shaft and configured to selectively couple and decouple the compressor system and the turbine system, respectively, to the drive shaft.

### BACKGROUND OF THE INVENTION

Embodiments of the invention relate generally to air compression and expansion systems and, more particularly, to air compression and expansion systems having a combined motor-generator unit and a single drive shaft coupled to compressors and expanders.

Air compression and expansion systems are used in a multitude of industries for a variety of applications. For example, one such application is the use of air compression and expansion systems as the turbomachinery in generating and storing energy. Compressed air energy storage (CAES) systems typically include a compression train having a plurality of compressors that compress intake air and provide the compressed intake air to a cavern, underground storage, or other compressed air storage component. The compressed air is then later used to drive turbines to produce energy such as, for example, electrical energy. During operation of the compression stage of a CAES system, the compressed intake air is typically cooled. During operation of the expansion stage, air is discharged from underground storage through turbines and expands such that the air exits the turbines at ambient pressure.

Typically, compressors and turbines in CAES systems are each connected to a generator/motor device through respective clutches, permitting operation either solely of the compressors or solely of the turbines during appropriate selected time periods. During off-peak periods of electricity demand in the power grid (i.e., nights and weekends), the compressor train is driven through its clutch by the generator/motor. In this scheme, the generator/motor functions as a motor, drawing power from a power grid. The compressed air is then cooled and delivered to underground storage. During peak demand periods, with the turbine clutch engaged, air is withdrawn from storage and then heated and expanded through a turbine train to provide power by driving the generator/motor. In this scheme, the generator/motor functions as a generator, providing power to a power grid, for example.

A typical arrangement of air compression and expansion system in a CAES system as known in the prior art is shown in FIG. 1. The air compression and expansion system 100 is configured to alternately operate in a compression mode and an expansion mode and includes a combined motor-generator unit 102, drive shafts 104, 106, clutches 108, 110, a compressor system 112, and a turbine system 114.

Motor-generator unit 102 is electrically connected to a baseload power supply via a power transmission line, and receives power therefrom during the compression mode of operation. During operation in the compression mode, motor-generator unit 102 generates rotational power that is transmitted to compressor system 112 by way of drive shaft 104. Clutch 108 is engaged to couple the compressor system 112 to the drive shaft 104 and motor-generator unit 102, thereby driving the compressor system 112 to compress air that is stored for subsequent power generation.

Upon switching of air compression and expansion system 100 to the expansion mode of operation, the supply of power to motor-generator unit 102 is terminated such that the transfer of rotational power to drive shaft 104 is terminated and compressor system 112 is no longer powered. Clutch 110 is then engaged to couple turbine system 114 to drive shaft 106 and motor-generator unit 102, allowing for power to be transferred from turbine system 114 to motor-generator unit 102. Upon delivery of the stored compressed air to turbine system 114, rotational power is provided from turbine system 114, which is transferred to motor-generator unit 102 by way of drive shaft 106.

While the inclusion of drive shafts 104, 106, clutches 108, 110, compressor system 112, and turbine system 114 in air compression and expansion system 100 functions to generate power, it is not without its drawbacks. For example, the arrangement of multiple drive shafts 104, 106 and clutches 108, 110 requires many components and much space. Furthermore, the arrangement of drive shafts 104, 106, clutches 108, 110, compressor system 112, and turbine system 114 in air compression and expansion system 100 does not allow for transfer of rotational power when transitioning from the compression mode to the expansion mode of operation. That is, a rotational power present in drive shaft 104 during the compression mode of operation cannot be transferred to drive shaft 106 for use during the expansion mode of operation. As such, a loss of power is realized that could otherwise be utilized were such rotational power to be transferred during transition from the compression mode to the expansion mode of operation.

Therefore, it would be desirable to design a system and method that overcomes the aforementioned drawbacks.

### BRIEF DESCRIPTION OF THE INVENTION

Embodiments of the invention provide a system and method for providing an air compression and expansion system having a combined motor-generator unit and a single drive shaft coupled to compressors and expanders.

In accordance with one aspect of the invention, an air compression and expansion system is provided that is operable in a compression mode and an expansion mode. The air compression and expansion system includes a motor-generator unit, a single drive shaft connected to the motor-generator unit and configured to transmit rotational power to and from the motor-generator unit, a compressor system selectively coupleable to the single drive shaft and positioned thereabout, and a turbine system selectively coupleable to the single drive shaft and positioned thereabout, the turbine system positioned with the compressor system on a common side of the motor-generator unit. The air compression and expansion system also includes a compressor clutch attached to the compressor system and arranged coaxially about the single drive shaft, the compressor clutch being configured to selectively couple and decouple the compressor system to the single drive shaft. The air compression and expansion system further includes a turbine clutch attached to the turbine system and arranged coaxially about the single drive shaft, the turbine clutch configured to selectively couple and decouple the turbine system to the single drive shaft.

In accordance with another aspect of the invention, a method for manufacturing a system for compressing and expanding gas during respective compression and expansion modes of operation is set forth. The method includes providing a combined motor-generator unit configured to generate both mechanical power and electrical power and coupling a single drive shaft to the motor-generator unit, with the single driveshaft coupled to receive a rotational power from the motor-generator unit and transmit a rotational power to the motor-generator unit. The method also includes arranging a compressor system and a turbine system about the single drive shaft and on a common side of the combined motor-generator unit to compress and expand gas during compression and expansion modes of operation, respectively. A first clutch mechanism is arranged coaxially about the drive shaft and is configured to selectively couple and decouple the compressor system to the single drive shaft during the compression and expansion modes of operation, and a second clutch mechanism is arranged coaxially about the drive shaft and is configured to selectively couple and decouple the turbine system to the single drive shaft during the compression and expansion modes of operation. The provided arrangement of the compressor and turbine systems and the first and second clutch mechanisms allows for constant rotation of the single drive shaft during a transition between the compression and expansion modes of operation.

In accordance with yet another aspect of the invention, a system for compressing and expanding gas and being operable in a compression mode and an expansion mode is provided. The system includes a combined motor-generator unit configured to both generate mechanical power and electrical power and a drive shaft connected to the motor-generator unit and configured to transmit rotational power to and from the motor-generator unit, with the drive shaft rotating in a uniform direction during each of the compression mode of operation and the expansion mode of operation. The system also includes a compressor system positioned on the drive shaft and configured to selectively compress gas when driven by rotational power from the drive shaft, a turbine system positioned on the drive shaft and configured to selectively expand gas to provide rotational power to the drive shaft, an actuatable clutch attached to the compressor system to selectively couple and decouple the compressor system to the drive shaft, and a free-wheel clutch attached to the turbine system to automatically couple and decouple the turbine system to the drive shaft. The drive shaft continues to rotate in the uniform direction during a transition from the compression mode of operation to the expansion mode of operation.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a block schematic diagram of an air compression and expansion system as known in the prior art.

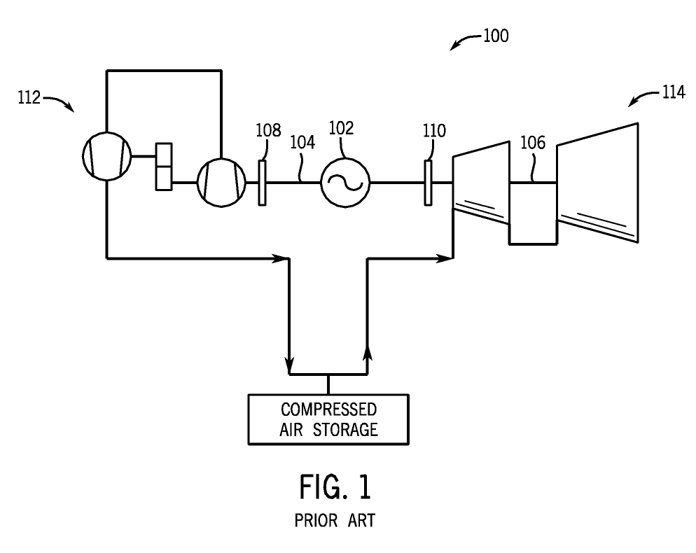

FIG. 2 is a block schematic diagram of an air compression and expansion system according to an embodiment of the present invention.

FIG. 3 is a block schematic diagram of an air compression and expansion system according to another embodiment of the present invention.

FIG. 4 is a block schematic diagram of a compressed air energy storage (CAES) system incorporating the air compression and expansion system of FIG. 2 according to an embodiment of the present invention.

### DETAILED DESCRIPTION

According to embodiments of the invention, an air compression and expansion system is provided having a combined motor-generator unit and a single drive shaft coupled to compressors and expanders.

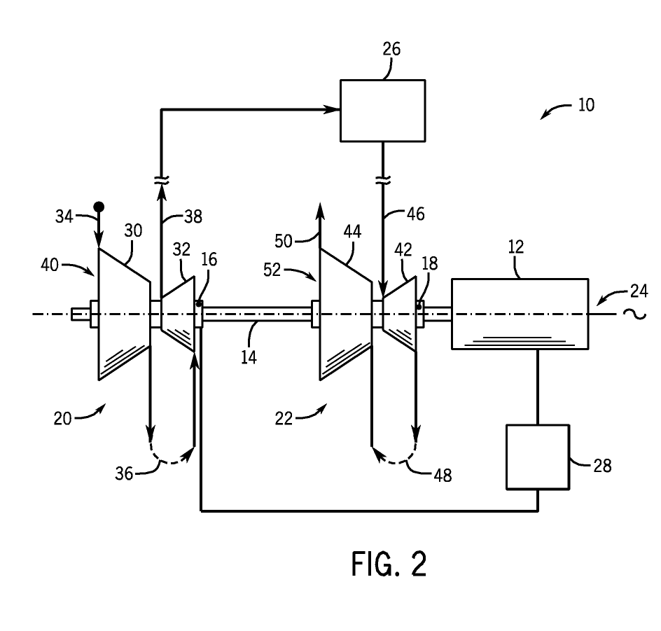

Referring to FIG. 2, an air compression and expansion system 10 is shown according to an embodiment of the invention. The air compression and expansion system 10 is configured to alternately operate in a compression mode and an expansion mode as determined by an operator. The air compression and expansion system 10 includes a combined motor-generator unit 12, a single drive shaft 14, compressor and turbine clutches 16, 18, a compressor system 20, and a turbine system 22. As shown in FIG. 2, compressor system 20 and turbine system 22 are each positioned coaxially about drive shaft 14 and on a same side of motor-generator unit 12, such that a single drive shaft 14 can be employed in air compression and expansion system 10. Similarly, each of compressor clutch 16 and turbine clutch 18 are positioned coaxially about drive shaft 14, with the compressor clutch 16 positioned between compressor system 20 and drive shaft 14 and turbine clutch 18 positioned between turbine system 22 and drive shaft 14. The coaxial clutches 16, 18 positioned on drive shaft 14 negate the need for compressor system 20 and turbine system to be mounted on separate shafts, but instead allows for the use of a single drive shaft 14 in air compression and expansion system 10.

During the compression mode of operation, motor-generator unit 12 is electrically connected to a baseload power source via a power transmission line 24 and receives power therefrom. The input of electrical power causes motor-generator unit 12 to operate in a motor mode, thereby generating a mechanical output of rotational power in response to the electrical power. The rotational power is transferred to drive shaft 14, thus causing the drive shaft to rotate. The compressor clutch 16 is engaged upon operation of air compression and expansion system 10 in the compression mode, thereby coupling compressor system 20 to the drive shaft 14 and motor-generator unit 12. Compressor system 20 is thus driven by the rotational power to compress air supplied thereto, with the compressed air being sent to a storage device 26, for example, for later use.

During operation of air compression and expansion system 10 in the compression mode, turbine clutch 18 is in a disengaged state such that turbine system 22 remains decoupled from drive shaft 14 and motor-generator unit 12. Turbine system 22 thus is not caused to rotate during the compression mode of operation, as it does not receive rotational power from drive shaft 14 and motor-generator unit 12.

When it is desired for air compression and expansion system 10 to operate in an expansion mode of operation, electrical power to motor-generator unit 12 is terminated, and air is retrieved from storage device 26 for expansion. In the expansion mode of operation, turbine clutch 18 is engaged such that turbine system 22 is engaged to the drive shaft 14 and motor-generator unit 12. Additionally, compressor clutch 16 is disengaged such that compressor system 20 is decoupled from the drive shaft 14 and motor-generator unit 12.

Upon switching to the expansion mode of operation, the previously compressed is retrieved from storage device 26 and provided to turbine system 22, which causes the turbine system 22 to generate rotational power. As turbine system 22 is coupled to drive shaft 14, the drive shaft receives the rotational power and transfers this power to motor-generator unit 12. The motor-generator unit 12 operates in a generator mode during the expansion mode of operation, and thus generates electrical power in response to the received rotational power output from turbine system 22.

According to an exemplary embodiment of the invention, motor-generator unit 12 and drive shaft 14 are configured such that drive shaft 14 rotates in a constant uniform direction during each of the compression and expansion modes of operation. Accordingly, in an exemplary embodiment of the invention, compressor clutch 16 and turbine clutch 18 are configured as an actuatable clutch and a free-wheeling clutch (i.e., self-synchronizing clutch), respectively. Actuatable clutch 16 is configured to selectively couple and decouple compressor system 20 to drive shaft 14 as determined by an operator of air compression and expansion system 10. Free-wheel clutch 18 is configured to automatically couple and decouple turbine system 22 to drive shaft 14 based upon the mode of operation and a speed of drive shaft 14.

In operation of air compression and expansion system 10, an operator can supply an input to determine whether the system operates in a compression or expansion mode of operation. The operator may provide such input by way of a controller 28, for example, that is connected to motor-generator unit 12 and to actuatable clutch 16. Upon an input by controller 28 commanding system 10 to operate in the compression mode of operation, actuatable clutch 16 is commanded to engage, such that compressor system 20 is coupled to drive shaft 14. During the compression mode of operation, free-wheel clutch 18 is in a disengaged state such that turbine system 22 is decoupled from drive shaft 14.

Upon an input by controller 28 commanding system 10 to operate in the expansion mode of operation, actuatable clutch 16 is commanded to disengage, such that compressor system 20 is decoupled from drive shaft 14 and the compressor system ceases to receive rotational power from the drive shaft. During transition from the compression mode of operation to the expansion mode of operation, drive shaft 14 continues to rotate. Free-wheel clutch 18 is configured to automatically engage turbine system 22 with drive shaft 14 during the expansion stage upon a speed of the turbine system becoming synchronized with a speed of the drive shaft. That is, compressed air is provided to turbine system 22 upon switching to the expansion mode of operation, thereby causing turbine system 22 to start rotating. Upon a rotational speed of turbine system 22 becoming synchronized with a speed of drive shaft 14, free-wheel clutch 18 automatically engages the turbine system to the drive shaft. As such, the arrangement of actuatable clutch 16 and free-wheeling clutch 18 allows for the rotational power of drive shaft 14 that is generated during the compression mode of operation to be conserved and utilized by air compression and expansion system 10 upon transition to the expansion mode of operation.

Referring still to FIG. 2, a configuration and arrangement of compressor system 20 and turbine system 22 is shown according to an exemplary embodiment of the invention. Compressor system 20 includes a low pressure compressor 30 and a high pressure compressor 32, along with an input conduit 34 to introduce air into low pressure compressor 30, a connecting conduit 36 to transfer air from the low pressure compressor 30 to the high pressure compressor 32, and an output conduit 38 to expel air from the high pressure compressor 32. The input conduit 34 is positioned on an outer edge 40 of low pressure compressor 30 and the output conduit 38 is positioned in an area of the compressor system between the low pressure compressor 30 and the high pressure compressor 32. The low and high pressure compressors 30, 32 are positioned adjacent one another and are arranged on the drive shaft to have opposite flow directions. The arrangement of low and high pressure compressors 30, 32 to have opposite flow directions allows for compensation/dispersement of axial forces resulting from the compressor stages, reduces bearing loads, and allows for coupling multiple compressor stages with one clutch (i.e., compressor clutch 16).

Similar to compressor system 20, turbine system 22 includes a low pressure turbine 42 and a high pressure turbine 44, along with an input conduit 46 to introduce compressed air into the high pressure turbine 44, a connecting conduit 48 to transfer air from the high pressure turbine 44 to the low pressure turbine 42, and an output conduit 50 to expel air from the low pressure turbine 42. The input conduit 46 is positioned in an area of the turbine system between the low pressure turbine 42 and the high pressure turbine 44 and the output conduit 50 is positioned on an outer edge 52 of the turbine system 22. The low and high pressure turbines 42, 44 are positioned adjacent one another and are arranged on the drive shaft to have opposite flow directions. The arrangement of low and high pressure turbines 42, 44 to have opposite flow directions allows for compensation and/or disbursement of axial forces resulting from the expansion stages, reduces bearing loads, and allows for coupling multiple expansion stages with one clutch (i.e., turbine clutch 18).

While the compressor system 20 and turbine system 22 shown in FIG. 2 are formed of a low pressure compressor 30 and a high pressure compressor 32 and of a low pressure turbine 42 and a high pressure turbine 44, respectively, it is recognized that the compressor system 20 and turbine system 22 could include a greater or lesser number of compressors/turbines. As such, it is recognized that compressor system 20 could be formed of a single compressor unit or of three or more compressor units. Similarly, turbine system 22 could be formed of a single turbine unit or of three or more turbine units. Air compression and expansion system 10 is thus not limited to the specific embodiment of FIG. 2, and compressor system 20 and turbine system 22 could be modified according to embodiments of the invention.

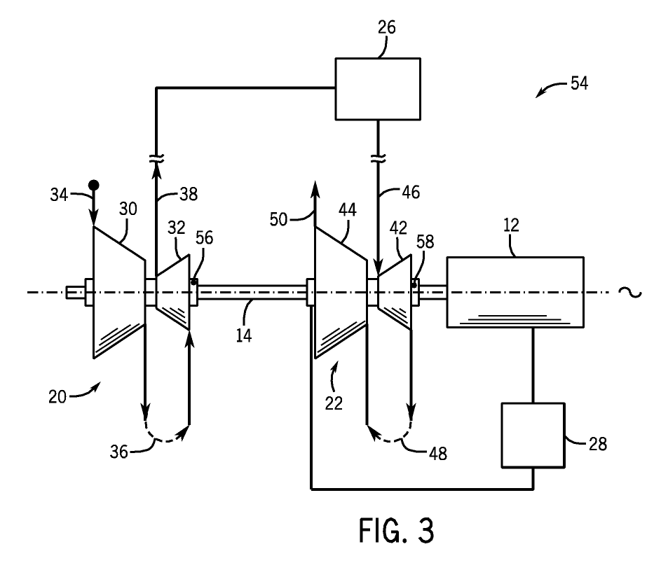

Referring now to FIG. 3, according to another embodiment of the invention, a compression and expansion system 54 includes a motor-generator unit 12 and drive shaft 14 configured such that drive shaft 14 rotates in a first direction during the compression mode of operation and in a second, opposite direction during the expansion mode of operation. Accordingly, a compressor clutch 56 attached to a compressor system 20 and a turbine clutch 58 attached to a turbine system 22 are configured as a free-wheeling clutch (i.e., self-synchronizing clutch) and an actuatable clutch, respectively. Free-wheel clutch 56 is configured to automatically couple and decouple compressor system 20 to drive shaft 14 based upon the mode of operation and a speed of drive shaft 14. Actuatable clutch 58 is configured to selectively couple and decouple turbine system 22 to drive shaft 14 as determined by input from an operator of air compression and expansion system 10.

In operation of air compression and expansion system 54, an operator supplies an input to determine whether the system operates in a compression or expansion mode of operation, such as by way of controller 28, for example, that is connected to motor-generator unit 12 and to actuatable clutch. Upon an input by controller 28 commanding system 54 to operate in the compression mode of operation, actuatable clutch 58 is commanded to disengage, such that turbine system 22 is decoupled from drive shaft 14. Drive shaft 14 is driven by motor-generator unit 12 in the compression stage and free-wheel clutch 56 acts to automatically engage compressor system 20 with drive shaft 14 during the compression stage upon drive shaft 14 reaching a desired speed. During transition from the compression mode of operation to the expansion mode of operation, free-wheel clutch 56 automatically disengages compression system 20 from drive shaft 14, such as when a speed of the drive shaft reaches a certain threshold rotational speed. Also during transition to the expansion mode of operation, rotation of drive shaft 14 is interrupted and controller 28 provides an input to actuatable clutch 58 to engage, thereby coupling turbine system 22 to drive shaft 14 to provide rotational power to the drive shaft and cause it to rotate in an opposite direction from that of the compression stage.

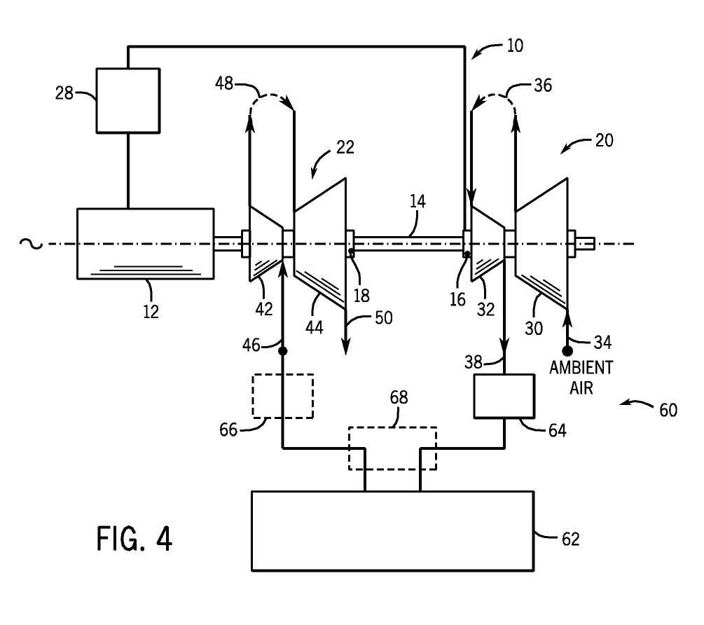

Referring to FIG. 4, a block diagram of an exemplary compressed air energy storage (CAES) system 60 is shown according to an embodiment of the invention. CAES system 60 includes an air compression and expansion system, such as air compression and expansion system 10 shown and described in FIG. 2, and also includes a compressed air storage volume 62.

According to an embodiment of the invention, motor-generator unit 12 drives drive shaft 14 during a compression mode of operation (i.e., compression stage). In turn, drive shaft 14 drives compression system 20, which includes a low pressure compressor 30 and a high pressure compressor 32, such that a quantity of ambient air enters ambient air intake 34 and is compressed by the compression system 20. Low pressure compressor 30 is coupled to high pressure compressor 32 via a compressor path 36. According to the present embodiment, low pressure compressor 30 compresses the ambient air. The compressed ambient air then passes along compressor path 36 to high pressure compressor 32, where the ambient air is further compressed before providing the compressed air along a compressed air path 38 to compressed air storage volume or cavern 62.

Though only two compressors 30, 32 are shown in the present embodiment, it is contemplated that compression system 20 could include more than two compressors. Similar to compressor path 36, embodiments having more than two compressors would include a compressor path through each compressor providing passage of air through the compression system.

According to the present embodiment, before the compressed air is stored in cavern 62, it is passed through a cooling unit 64 that removes heat from the compressed air prior to storage of the cavern. By removing heat from the compressed air prior to storage, the integrity of cavern 62 is protected. It is contemplated that other coolers such as an intercooler (not shown) could be utilized along compressor path 36 to cool air as it travels through compression system 20.

After compressed air is stored in compressed air storage volume 62, compressed air can be allowed to pass along exit path 46, where it is reheated via heating unit 66. After the compressed air is reheated, the compressed air proceeds down the exit path 46 to turbine system 22. Due to the configuration of turbine system 22, the compressed air is allowed to expand as it passes therethrough; thus, causing rotation of turbine system 22. It is contemplated that turbine system 22 includes one or more turbines to facilitate power generation, such as a low pressure turbine 42 and a high pressure turbine 44. The rotation of turbine system 22 causes a drive shaft 14 to rotate. In turn, drive shaft 14 drives motor-generator unit 12, causing the unit to function as a generator to produce electricity. It is further contemplated that additional heaters or combustors could be placed before, as well as in between, the stages of turbine system 22.

In an alternate embodiment, CAES system 60 is an adiabatic system that includes a thermal energy storage (TES) system TES system 68. In such an embodiment, compressed air passing along compressed air path 38 to cavern 62 passes through TES system 68, which removes heat from the compressed air. The heat is stored by TES system 68, and is later conveyed back to the compressed air as the compressed air passing along exit path 46 passes back through TES system 68. In such an embodiment, the need for heating unit 66 may be avoided.

While the compressor system 20 and turbine system 22 shown in FIG. 3 are formed of a low pressure compressor 30 and a high pressure compressor 32 and of a low pressure turbine 42 and a high pressure turbine 44, respectively, it is recognized that the compressor system 20 and turbine system 22 could include a greater or lesser number of compressors/turbines. Additionally, it is recognized that additional cooling units 64 and/or heating units 66 could be included in CAES system 60 between stages of compressor system 20 and turbine system 22, respectively. Alternatively, it is recognized that additional TES systems 68 could be included in CAES system 60 between stages of compressor system 20 and turbine system 22.

While air compression and expansion system 10 is discussed above as being implemented for use in a CAES system 60, it is recognized that embodiments of the invention may be implemented in any of a number of systems. Embodiments of the invention are thus recognized as capable of being implemented in other types of systems not specifically described or set forth above.

Therefore, according to one embodiment of the invention, an air compression and expansion system is provided that is operable in a compression mode and an expansion mode. The air compression and expansion system includes a motor-generator unit, a single drive shaft connected to the motor-generator unit and configured to transmit rotational power to and from the motor-generator unit, a compressor system selectively coupleable to the single drive shaft and positioned thereabout, and a turbine system selectively coupleable to the single drive shaft and positioned thereabout, the turbine system positioned with the compressor system on a common side of the motor-generator unit. The air compression and expansion system also includes a compressor clutch attached to the compressor system and arranged coaxially about the single drive shaft, the compressor clutch being configured to selectively couple and decouple the compressor system to the single drive shaft. The air compression and expansion system further includes a turbine clutch attached to the turbine system and arranged coaxially about the single drive shaft, the turbine clutch configured to selectively couple and decouple the turbine system to the single drive shaft.

According to another embodiment of the invention, a method for manufacturing a system for compressing and expanding gas during respective compression and expansion modes of operation is set forth. The method includes providing a combined motor-generator unit configured to generate both mechanical power and electrical power and coupling a single drive shaft to the motor-generator unit, with the single driveshaft coupled to receive a rotational power from the motor-generator unit and transmit a rotational power to the motor-generator unit. The method also includes arranging a compressor system and a turbine system about the single drive shaft and on a common side of the combined motor-generator unit to compress and expand gas during compression and expansion modes of operation, respectively. A first clutch mechanism is arranged coaxially about the drive shaft and is configured to selectively couple and decouple the compressor system to the single drive shaft during the compression and expansion modes of operation, and a second clutch mechanism is arranged coaxially about the drive shaft and is configured to selectively couple and decouple the turbine system to the single drive shaft during the compression and expansion modes of operation. The provided arrangement of the compressor and turbine systems and the first and second clutch mechanisms allows for constant rotation of the single drive shaft during a transition between the compression and expansion modes of operation.

According to yet another embodiment of the invention, a system for compressing and expanding gas a system for compressing and expanding gas and being operable in a compression mode and an expansion mode is provided. The system includes a combined motor-generator unit configured to both generate mechanical power and electrical power and a drive shaft connected to the motor-generator unit and configured to transmit rotational power to and from the motor-generator unit, with the drive shaft rotating in a uniform direction during each of the compression mode of operation and the expansion mode of operation. The system also includes a compressor system positioned on the drive shaft and configured to selectively compress gas when driven by rotational power from the drive shaft, a turbine system positioned on the drive shaft and configured to selectively expand gas to provide rotational power to the drive shaft, an actuatable clutch attached to the compressor system to selectively couple and decouple the compressor system to the drive shaft, and a free-wheel clutch attached to the turbine system to automatically couple and decouple the turbine system to the drive shaft. The drive shaft continues to rotate in the uniform direction during a transition from the compression mode of operation to the expansion mode of operation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An air compression and expansion system operable in a compression mode and an expansion mode, the air compression and expansion system comprising:
a motor-generator unit;
a single drive shaft connected to the motor-generator unit and configured to transmit rotational power to and from the motor-generator unit;
a compressor system selectively coupleable to the single drive shaft and positioned thereabout;
a turbine system selectively coupleable to the single drive shaft and positioned thereabout, the turbine system positioned with the compressor system on a common side of the motor-generator unit;
a compressor clutch arranged coaxially about the single drive shaft and attached to the compressor system, the compressor clutch configured to selectively couple and decouple the compressor system to the single drive shaft; and
a turbine clutch arranged coaxially about the single drive shaft and attached to the turbine system, the compressor clutch configured to selectively couple and decouple the turbine system to the single drive shaft.

2. The air compression and expansion system of claim 1 wherein the compressor clutch comprises an actuatable clutch configured to selectively couple and decouple the compressor system to the drive shaft; and
wherein the turbine clutch comprises a free-wheel clutch configured to automatically couple and decouple the turbine system to the drive shaft.

3. The air compression and expansion system of claim 2 wherein the drive shaft rotates in a single direction during each of the compression and expansion stages.

4. The air compression and expansion system of claim 2 wherein the free-wheel clutch is configured to automatically couple the turbine system with the drive shaft during the expansion stage upon a rotational speed of the turbine system becoming synchronized with a rotational speed of the drive shaft.

5. The air compression and expansion system of claim 1 the compressor clutch comprises a free-wheel clutch configured to automatically couple and decouple the compressor system with the drive shaft; and
wherein the turbine clutch comprises an actuatable clutch configured to selectively couple and decouple the turbine system with the drive shaft.

6. The air compression and expansion system of claim 5 wherein the drive shaft rotates in a first direction during the compression stage and rotates in a second direction opposite from the first direction during the expansion stage.

7. The air compression and expansion system of claim 1 wherein the compression system comprises:
a low pressure compressor; and
a high pressure compressor positioned adjacent the low pressure compressor;
wherein the low pressure compressor and the high pressure compressor are arranged on the drive shaft to have opposite flow directions.

8. The air compression and expansion system of claim 7 wherein the compression system further comprises:
an input conduit to introduce air into the low pressure compressor, the input conduit being positioned on an outer edge of the compression system;
a connecting conduit to transfer air from the low pressure compressor to the high pressure compressor; and
an output conduit to expel air from the high pressure compressor, the output conduit being positioned in an area of the compression system between the low pressure compressor and the high pressure compressor.

9. The air compression and expansion system of claim 1 wherein the turbine system comprises:
a low pressure turbine; and
a high pressure turbine positioned adjacent the low pressure turbine;
wherein the low pressure turbine and the high pressure turbine are arranged on the drive shaft to have opposite flow directions.

10. The air compression and expansion system of claim 9 wherein the turbine system further comprises:
an input conduit to introduce compressed air into the high pressure turbine, the input conduit being positioned in an area of the turbine system between the low pressure turbine and the high pressure turbine;
a connecting conduit to transfer air from the high pressure turbine to the low pressure turbine; and
an output conduit to expel air from the low pressure turbine, the output conduit being positioned on an outer edge of the turbine system.

11. The air compression and expansion system of claim 1 wherein the compression system and the turbine system are aligned coaxially on the drive shaft.

12. The air compression and expansion system of claim further 1 comprising a controller configured to selectively actuate one of the compressor clutch and the turbine clutch to selectively couple and decouple one of the compressor system and the turbine system to the drive shaft.

13. A method for manufacturing a system for compressing and expanding gas during respective compression and expansion modes of operation, the method comprising:
providing a combined motor-generator unit configured to generate both mechanical power and electrical power;
coupling a single drive shaft to the motor-generator unit, the single driveshaft coupled to receive a rotational power from the motor-generator unit and transmit a rotational power to the motor-generator unit;
arranging a compressor system and a turbine system about the single drive shaft and on a common side of the combined motor-generator unit to compress and expand gas during compression and expansion modes of operation, respectively;
arranging a first clutch mechanism coaxially about the drive shaft, the first clutch mechanism configured to selectively couple and decouple the compressor system to the single drive shaft during the compression and expansion modes of operation; and
arranging a second clutch mechanism coaxially about the drive shaft, the second clutch mechanism configured to selectively couple and decouple the turbine system to the single drive shaft during the compression and expansion modes of operation;
wherein the arrangement of the compressor and turbine systems and the first and second clutch mechanisms allow for constant rotation of the single drive shaft during a transition between the compression and expansion modes of operation.

14. The method of claim 13 wherein providing the first clutch mechanism comprises providing an actuatable clutch coupled to the compressor system to selectively couple and decouple the compressor system with the single drive shaft.

15. The method of claim 13 wherein providing the second clutch mechanism comprises providing a self-synchronizing clutch coupled to the turbine system to automatically couple and decouple the turbine system with the drive shaft, the self-synchronizing clutch configured to automatically engage the turbine system with the drive shaft upon a rotational speed of the turbine system becoming synchronized with a rotational speed of the drive shaft.

16. The method of claim 13 wherein providing the compression system comprises providing a low pressure compressor and a high pressure compressor, the low pressure compressor and the high pressure compressor being arranged on the single drive shaft to have opposite flow directions; and
wherein providing the turbine system comprises providing a low pressure turbine and a high pressure turbine, the low pressure turbine and the high pressure turbine being arranged on the single drive shaft to have opposite flow directions.

17. A system for compressing and expanding gas and being operable in a compression mode and an expansion mode, the system comprising:
a combined motor-generator unit configured to both generate mechanical power and electrical power;
a drive shaft connected to the motor-generator unit and configured to transmit rotational power to and from the motor-generator unit, the drive shaft rotating in a uniform direction during each of the compression mode of operation and the expansion mode of operation;
a compressor system positioned on the drive shaft and configured to selectively compress gas when driven by rotational power from the drive shaft;
a turbine system positioned on the drive shaft and configured to selectively expand gas to provide rotational power to the drive shaft;
an actuatable clutch attached to the compressor system to selectively couple and decouple the compressor system to the drive shaft; and
a free-wheel clutch attached to the turbine system to automatically couple and decouple the turbine system to the drive shaft;
wherein the drive shaft continues to rotate in the uniform direction during a transition from the compression mode of operation to the expansion mode of operation.

18. The system of claim 17 further comprising a controller configured to alternately operate the system in the compression mode and the expansion mode.

19. The system of claim 18 wherein the controller is configured to:
operate the combined motor-generator unit in a motor mode during the compression mode of operation and in a generator mode during the expansion mode of operation;
actuate the actuatable clutch during the compression mode of operation to couple the compressor system to the drive shaft; and
actuate the actuatable clutch during the expansion mode of operation to decouple the compressor system from the drive shaft.

20. The system of claim 17 wherein the free-wheel clutch is configured to decouple the turbine system from the drive shaft during the compression mode of operation and couple the turbine system to the drive shaft during the expansion mode of operation.

21. The system of claim 20 wherein the free-wheel clutch comprises a self-synchronizing clutch configured to automatically engage the turbine system with the drive shaft upon a rotational speed of the turbine system becoming synchronized with a rotational speed of the drive shaft.
